(19) United States
(12) Patent Application Publication
(10) Pub. No.: US 2006/0072031 A1
(43) Pub. Date: Apr. 6, 2006

(54) Mobile communication terminal equipped with digital image capturing module and method of capturing digital image

(75) Inventor: Dong-Uk Min, Seodaemun-Gu (KR)

Correspondence Address: OBLON, SPIVAK, MCCLELLAND, MAIER & NEUSTADT, P.C., 1940 DUKE STREET, ALEXANDRIA, VA, 22314, US

(73) Assignee: CURITEL COMMUNICATIONS, INC., Seocho-Gu (KR)

(21) Appl. No.: 11/023,526

(22) Filed: Dec. 29, 2004

(30) Foreign Application Priority Data
Oct. 1, 2004 (KR) 10-2004-0078442
Oct. 1, 2004 (KR) 10-2004-0078443

(51) Int. Cl. H04N 5/235

(52) U.S. Cl. 348/362

(57) ABSTRACT

Disclosed are a mobile communication terminal equipped with a digital image capturing module and a method of capturing a digital image. The mobile communication terminal includes: a camera module for acquiring digital image data; a storage unit for storing the acquired digital image data; a display unit for displaying the acquired digital image data; and a control module for calculating mean luminance values of frames acquired during a predetermined time, calculating an image's luminance value by averaging the mean luminance values of all the frames except frames having significantly high deviations in mean luminance, and transmitting to the camera module a control instruction for controlling an exposure time based on the image's luminance value at regular intervals. The method includes the steps of: converting an analog image signal captured by the image pickup unit into digital image data; calculating a luminance value of the image based on the digital image data; and controlling an exposure time of the image pickup unit according to the calculated luminance value.

### BACKGROUND OF THE INVENTION

This application claims the priorities of Korean Patent Application Nos. 2004-78442 and 2004-78443, filed on Oct. 1, 2004, in the Korean Intellectual Property Office, the disclosures of which are incorporated herein in their entirety by reference.

1. Field of the Invention

The present invention relates to a mobile communication terminal and, more particularly, to a mobile communication terminal having the function of capturing a digital image and a method of capturing the digital image.

2. Description of the Related Art

In general, a digital camera converts an image signal captured by an image pickup unit into digital data, stores the digital data, and displays the stored digital data. The image pickup unit outputs a signal proportional to an optical signal or light, so that the luminance of a target object is reflected in the captured image. When the luminance of the target object is too high or low, the quality of the captured image may be deteriorated.

To solve the above-mentioned problem, the digital camera includes an additional illumination sensor which detects ambient luminance. Accordingly, the digital camera automatically adjusts its iris based on the detected luminance, thereby improving image quality. However, adding the additional illumination sensor would make it difficult to configure a compact digital camera or mobile communication terminal equipped with a digital camera module.

### SUMMARY OF THE INVENTION

The present invention provides a mobile communication terminal equipped with a digital camera module having the function of automatically adjusting a capture mode based on the luminance of a target object without using additional components, and a method of capturing a digital image which maintains stable luminance.

In accordance with an aspect of the present invention, there is provided a mobile communication terminal comprising: a camera module for acquiring digital image data; a storage unit for storing the acquired digital image data; a display unit for displaying the acquired digital image data; and a control module for calculating mean luminance values of frames acquired during a predetermined time, calculating an image's luminance value by averaging the mean luminance values of all the frames except frames having significantly high deviations in mean luminance, and transmitting to the camera module a control instruction for controlling an exposure time based on the image's luminance value at regular intervals.

The control instruction outputted from the control module may be data associated with the number of frames per second.

The mobile communication terminal may further comprise a signal processing module for processing the digital image data outputted from the camera module, storing the processed digital image data in the storage unit, and outputting to the display unit the digital image data which is processed or read from the storage unit.

The signal processing module may further comprise a color converter for converting color component values of the digital image data, and the control module may comprise: a luminance calculator for calculating a luminance value of a target object from the digital image data; an exposure controller for determining an exposure time of a image pickup unit on the basis of the luminance value calculated by the luminance calculator, and transmitting an exposure time control instruction to the camera module; and a color conversion controller for controlling a color conversion scheme of the color converter on the basis of the luminance value calculated by the luminance calculator.

The color converter may select any one of conversion tables according to a control instruction of the color conversion controller, and perform a mapping operation of at least U and V signals from among input signals by the selected conversion table.

The control module may comprise: a luminance calculator for calculating an image's luminance value by calculating mean luminance values of frames acquired during a predetermined time and averaging the mean luminance values of all the frames except frames having significantly high deviations in mean luminance; and an exposure controller for transmitting to the camera module a control instruction for controlling an exposure time based on the image's luminance value at regular intervals.

The luminance calculator may calculate an image's luminance value by averaging mean luminance values of all frames during a predetermined time except frames having mean luminance values greater than a mean luminance value of a previous frame by a predetermined value.

The luminance calculator may calculate an image's luminance value by calculating a mean value of the mean luminance values of the frames acquired during the predetermined time, and averaging the mean luminance values of all the frames except frames having significantly high deviations as compared to the calculated mean value of the mean luminance values of the frames.

The control module may control operation of the camera module using a serial bus.

In accordance with another aspect of the present invention, there is provided a method of capturing an image using an image pickup unit, comprising the steps of: a) converting an analog image signal captured by the image pickup unit into digital image data; b) calculating a luminance value of the image based on the digital image data; and c) controlling an exposure time of the image pickup unit according to the calculated luminance value.

The step b) may comprise the steps of: b1) calculating mean luminance values of image frames acquired during a predetermined time; and b2) calculating an image's luminance value by averaging the mean luminance values of all the frames except frames having significantly high deviations in mean luminance as compared to a reference value.

The step b2) may comprise the step of calculating an image's luminance value by averaging mean luminance values of all frames during a predetermined time except frames having mean luminance values greater than a mean luminance value of a previous frame by a predetermined value.

The step b2) may comprise the steps of: calculating a mean value of the mean luminance values of the frames acquired during the predetermined time; and calculating an image's luminance value by averaging the mean luminance values of all the frames except frames having significantly high deviations as compared to the calculated mean value of the mean luminance values of the frames.

The method may further comprise the step of d) performing a mapping operation of colors of the digital image data according to the calculated image's luminance value.

The step d) may comprise the step of selecting any one of conversion tables and performing a mapping operation of at least U and V signals from among the digital image data by the selected conversion table.

The step c) may comprise the step of controlling the number of frames per second of the image pickup unit.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram showing a mobile communication terminal in accordance with an embodiment of the present invention; and

FIG. 2 is a flowchart showing a method of capturing an image in a mobile communication terminal in accordance with an embodiment of the present invention.

### DESCRIPTION OF THE PREFERRED EMBODIMENTS

Exemplary embodiments in accordance with the present invention will now be described in detail with reference to the annexed drawings.

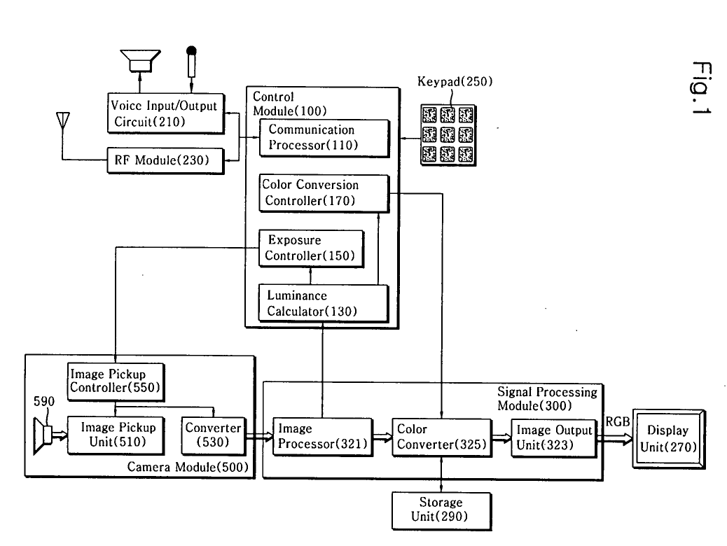

FIG. 1 is a block diagram showing a mobile communication terminal in accordance with an embodiment of the present invention. The mobile communication terminal comprises a camera module 500 for acquiring digital image data, a storage unit 290 for storing the digital image data, a display unit 270 for displaying the digital image data, and a control module 100 for calculating a luminance value of a target object based on the digital image data and outputting a control instruction for adjusting the exposure time of the camera module 500 on the basis of the calculated luminance value. The display unit 270 displays menu and operation state information in addition to the digital image data. A liquid crystal display (LCD) is an example of the display unit 270.

The mobile communication terminal also comprises a keypad 250, a radio frequency (RF) module 230 for extracting voice and data signals from RF signals transmitted over an antenna, and a voice input/output (I/O) circuit 210 for inputting/outputting voice communication signals received from the RF module 230 through a microphone or a speaker.

The RF module 230, which includes an antenna and an RF circuit, communicates with a base station. In this specification, the RF module 230 is explicated to be available in mobile communication schemes which will appear in the future, as well as the existing mobile communication schemes such as CDMA, TDMA, PDC, and GSM. The voice I/O circuit 210 converts digital voice data into an analog voice signal or vice versa, and includes additional circuits such as audio amplifier or filter as well known in the art.

Baseband processing circuits in the RF module 230 and the phone control module 100 are integrated into a commercially available single chip, which is usually called a mobile station modem (MSM) chip. Such an integrated circuit (IC) chip includes dedicated hardware for processing communication services, a digital signal processor, and a general-purpose microprocessor.

The camera module 500 converts an optical signal received through a lens system into an electric signal, and outputs the electric signal. A signal processing module 300 processes an image signal outputted from the camera module 500, and outputs the processed image signal to the display unit 270 or stores the image signal in the storage unit 290, such as built-in or detachable flash memory, or hard disk.

In accordance with a preferred embodiment of the present invention, control signals are exchanged among the control module 100, the signal processing module 300, and the camera module 500 via a serial bus, which is an I²C bus in an embodiment of the present invention. The I²C bus, also called an “Inter-IC bus”, is a serial bus developed by Philips Electronics and a two-wire, bidirectional serial bus that provides a serial data line and a serial clock line interface to exchange information between devices.

In accordance with another preferred embodiment of the present invention, the camera module 500 includes a lens system 590; an image pickup unit 510; a converter 530 for converting an analog image signal captured by the image pickup unit 510 into digital image data; and an image-pickup controller 550 for outputting a control signal to the image pickup unit 510 according to a control instruction from the control module 100. The lens system 590, composed of one or more compact lenses, focuses and provides light to the image pickup unit 510.

The image pickup unit 510, which is typically constructed of a complementary metal-oxide-semiconductor (CMOS) or a charge coupled device (CCD) image sensor, is a well-known component used for converting light into electrical signals in each pixel and sequentially outputting the converted electrical signals in synchronization with clocks. An optical-charge charging time corresponds to an exposure time during which a film is exposed to light in a conventional film-type camera. The above-mentioned optical-charge charging time is controlled by the frequency and duty of a clock generated in the image-pickup controller 550.

In accordance with another preferred embodiment of the present invention, the exposure time of the image pickup unit 510 is adjusted based on frame rate. For example, the available exposure time for outputting image data at a frame rate of 30 times per second is shorter than the available exposure time for outputting image data at a frame rate of 20 times per second.

The converter 530 converts a current or voltage signal stream, which is proportional to the luminance of an image outputted from the image pickup unit 510, into a digital data stream, which is in turn converted into a YUV format.

The image-pickup controller 550 controls the overall operation of the camera module 500 according to external instruction data received over the I²C bus. In accordance with another preferred embodiment of the present invention, the image-pickup controller 550 controls an exposure time of the image pickup device by outputting a control signal to the image pickup unit 510 according to an exposure time control instruction received from an exposure controller 150 contained in the control module 100. The image-pickup controller 550 in the camera module 500 may be implemented with a microprocessor or a simple digital logic circuit. The image-pickup controller 550 provides the image pickup device with a driving clock for capturing image data. The control instruction for controlling the exposure time, which is output from the image pickup unit 510, may be the driving clock. For example, an optical-charge collection time of each pixel in the image pickup device, i.e., an exposure time, can be controlled by the driving clock. The converter 530 carries out data conversion in synchronization with the driving clock.

The control module 100 includes a communication processor 110 for controlling voice and data communications. In accordance with another preferred embodiment of the present invention, the control module 100 includes a luminance calculator 130 and an exposure controller 150.

The luminance calculator 130 calculates luminance values from image data converted by the converter 530. In accordance with another preferred embodiment of the present invention, the luminance value of the target object is obtained by averaging luminance values of image data associated with a single frame. In accordance with another preferred embodiment of the present invention, the luminance value of the target object is obtained by averaging the mean luminance values of frames in a predetermined time interval, except frames having high deviations in mean luminance. The above-mentioned luminance calculation method will be described below.

The exposure controller 150 determines an exposure time of the image pickup unit 510 on the basis of the luminance value calculated by the luminance calculator 130, and outputs an exposure time control instruction to the image-pickup controller 550.

The luminance values of the target object are divided into a predetermined number of groups for convenience of control. In accordance with an embodiment of the present invention, assuming that the luminance value of the target object calculated by averaging luminance values is denoted by “Y”, the luminance values are divided into three groups which are controlled differently from each other. The three groups are as follows:
Y: 0˜34 (0˜5 lux)→Dark-Night Mode,
Y: 35˜88 (6˜120 lux)→Night Mode,
Y: 89˜255 (over 120 lux)→Day Mode

In accordance with another preferred embodiment of the present invention, the control signal generated from the exposure controller 150 is data associated with the number of frames per second. In more detail, if the “Y” value detected by the exposure controller 150 indicates Dark-Night Mode, the exposure controller 150 outputs the control signal to increase the exposure time of the image pickup unit 510, thereby reducing the number of captured frames per second. As a result, the exposure time for each frame increases so that the image pickup unit 510 can receive sufficient light.

In the case of Dark-Night Mode, for example, the frame rate reduces to 10 frames per second to increase the exposure time. In the case of Night Mode, the frame rate is limited to about 20 frames per second for a proper exposure time. In the case of Day mode, the frame rate is set to a normal frame rate, i.e., 30 frames per second. Therefore, it is possible to secure the exposure time enough to acquire a fine and clear image even in poor lighting conditions.

In this manner, the luminance of a captured image is detected and the luminance of an image to be captured is controlled on the basis of the detected luminance. Accordingly, the exposure time is automatically controlled without the need to use an additional illumination sensor for detecting the luminance of the captured image.

The signal processing module 300 receives and processes YUV format image data from the camera module 500 and stores the signal-processed YUV image data in the storage unit 290. The signal processing module 300 outputs the signal-processed image data directly to the display unit 270, or the signal-processed image data from the storage unit 290 to the display unit 270. In accordance with another preferred embodiment of the present invention, the signal processing module 300 includes an image processor 321 and an image output unit 323.

The image processor 321 performs an image-enhancing process for image data received from the converter 530, compresses and stores the image data in the storage unit 290 or decompresses the image data stored in the storage unit 290. The image data stored in the storage unit 290 may be moving image data, or still image data captured from an input frame.

The image output unit 323 converts the image data outputted from the image processor 321 or from the storage unit 290 into a format suitable for the display unit 270, buffers and outputs the converted data.

In accordance with another preferred embodiment of the present invention, the signal processing module 300 further includes a color converter 325, and the controller 310 further includes a color conversion controller 170. The color converter 325 converts color components U and V from among the YUV format image data, which is converted into digital image data in the converter 530 and outputted from the converter 530, under the control of the color conversion controller 170.

The color conversion controller 170 controls U and V mapping operations of the color converter 325 according to luminance values calculated by the luminance calculator 130. Increasing the luminance of a captured image in a dark environment by an increased exposure time may deteriorate the color quality of the image. In accordance with another preferred embodiment of the present invention, the color converter 325 has optimum U and V conversion tables with respect to each of the modes, and performs the mapping operations of U and V data using a conversion table selected under the control of the color conversion controller 170. In accordance with another preferred embodiment of the present invention, the color conversion controller 170 operates with the same algorithm as the exposure controller 150. In this case, the color conversion controller 170 and the exposure controller 150 may be integrated into a single unit. In accordance with another preferred embodiment of the present invention, the color conversion controller 170 can provide more detailed modes as compared to the exposure controller 150.

The conversion table may be experimentally calculated. In more detail, the conversion table is obtained through observation of color values by the naked eye, where the color values are corrected simultaneously when the luminance value of each mode is corrected. That is, the mobile communication terminal in accordance with the present invention controls both the color and luminance of a captured image to obtain a suitable luminance and color.

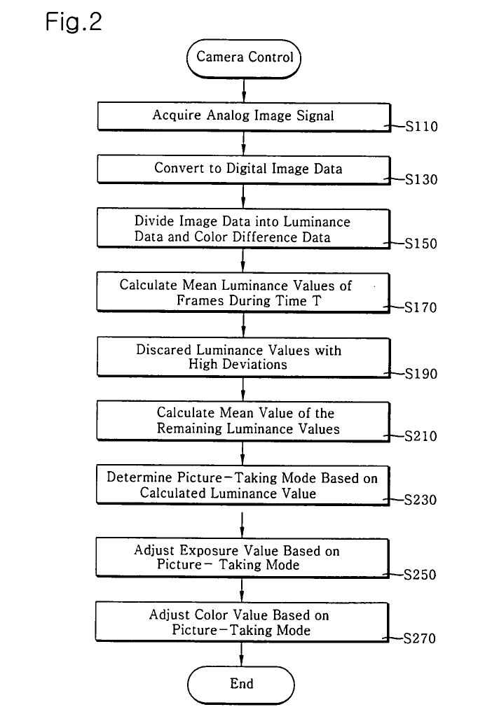

FIG. 2 is a flowchart showing a method of capturing an image in a mobile communication terminal in accordance with an embodiment of the present invention. The method comprises the steps of converting an analog image signal captured by the image pickup unit 510 into digital image data (S110 and S130), calculating a luminance value of a desired image based on the digital image data (S150, S170, S190, and S210), and controlling the exposure time of the image pickup unit 510 based on the luminance value (S230 and S250).

The image pickup unit 510 converts light focused by the lens system 590 into an electrical analog image signal (step S110). The analog image signal is subjected to amplifying and pre-filtering operations and then converted into digital image data in the converter 530 (step S130). The converted digital image data is divided into luminance data and color-difference data and then converted to a YUV signal with the ratio of Y, U, and V being 4:2:2 (step S150).

In accordance with another preferred embodiment of the present invention, the step of calculating the luminance value of a desired image includes the steps of calculating a mean luminance value of each of image frames in a predetermined time interval (step S170) and averaging mean luminance values of all the frames except frames having significantly high deviations in mean luminance as compared to a predetermined reference value (steps S190 and S210).

Accordingly, it is possible to prevent an image pickup mode from being frequently changed, or prevent the image pickup mode from being changed differently from a real situation. That is, in the case of adjusting an exposure time based on input image luminance, a mode may be changed to another mode in the vicinity of boundary areas between individual modes. For example, when a mode is set to Night mode according to a luminance value read out at a boundary value of 88 at which the Day mode is changed to the Night mode and then an exposure time is increased, a luminance value of an input image is improved such that the mode returns to the Day mode. Experiments have shown that the boundary value is determined in the luminance values ranging from 82 to 88. Similarly, when a mode is set to Dark-Night mode at a boundary value of 34 at which the Night mode is changed to the Dark-Night mode and then the exposure time is increased, the luminance value of the input image is improved such that the mode returns to the Night mode. Experiments have shown that the boundary value is determined in the luminance values ranging from 29 to 34. The above-mentioned mode conversion may occur due to other causes. For example, when a target object is black, the mode conversion may frequently occur due to a low mean luminance value even though its background is bright. In addition, when focal points of the camera are rapidly changed, the mode convention may frequently occur according to deviation in the target object. The above-mentioned frequent conversion of mode significantly deteriorates image quality. An image pickup method in accordance with the present invention, which will be described below, can solve the above-mentioned problem.

In accordance with another preferred embodiment of the present invention, the luminance calculator 130 calculates mean luminance values of frames during a predetermined time, and averages the mean luminance values of all the frames except frames having significantly high deviations in mean luminance as compared to the averaged luminance value, which is determined to be the luminance of an image. In more detail, the luminance calculator 130 calculates a mean luminance value associated with each of frames (e.g., 30 frames) generated during a predetermined time ‘T’ (e.g., 1 second). The value of T, which is experimentally calculated, is a unit time for changing an image pickup mode. The mean luminance value of a frame is obtained by averaging luminance values of all pixels composing a single frame (step S170). Luminance values having significantly high deviations in mean luminance as compared to a reference value are discarded (step S190). The reference value is a value obtained by averaging mean luminance values of the frames generated during a predetermined time of T. That is, values significantly deviating from the reference value are eliminated. In the case of the Night mode, for example, mean luminance values deviating from the reference value by 6 or more are discarded.

In accordance with another preferred embodiment of the present invention, the luminance of an image is determined by averaging mean luminance values of all the frames during a predetermined time except frames having mean luminance values greater than a mean luminance value of a previous frame by a predetermined value. In more detail, the mean luminance values of frames are sequentially stored. A mean luminance value of a current frame is compared with that of a previous frame. If a difference between the two mean luminance values is equal to or greater than a predetermined value, the mean luminance value of the current frame is discarded. For example, if a current mode is the Night mode, a frame with a mean luminance value deviating from a mean value of the previous frame by 6 or more is discarded. The above-mentioned operation is repeated for a plurality of frames generated during a predetermined time (e.g., 30 frames per second).

Subsequently, a mean value of the mean luminance values of the frames not discarded is calculated (step S210). Based on the calculated mean value, a picture-taking mode is determined to be one of Day mode, Night mode, and Dark-night mode (step S230).

Assuming that Y4−Y3=8, Y10−Y9=11, Yn+1−Yn≦6, and Y=(Y1+Y2+ . . . +Y30)/28=85 (i.e., a mean value except for Y4 and Y10 values), the controller sets the picture-taking mode to be the Night mode.

After the picture-taking mode is determined as mentioned above, an exposure value is adjusted according to the picture-taking mode (step S250). In accordance with another preferred embodiment of the present invention, the exposure value is controlled by the number of frames per second. The exposure controller 150 determines the number of frames per second according to individual picture-taking modes. For example, the number of frames per second is 20 in the Dark-Night mode, 30 in the Night mode, and 40 in the Day mode. Subsequently, a color value is controlled according to the determined picture-taking mode (step S270). The color value is controlled by selecting a mapping table according to the picture-taking mode, and mapping U and V values according to the selected mapping table.

As apparent from the above description, a mobile terminal communication terminal in accordance with the present invention detects a luminance value of a captured image, and automatically adjusts an exposure value according to the detected luminance value. Accordingly, there is no need to use an additional illumination sensor for detecting the luminance of the captured image, resulting in reduced components, reduced production costs, and improved image quality.

The mobile communication terminal in accordance with the present invention properly converts the color of a captured image according to the luminance of the captured image.

Further, the mobile communication terminal properly controls an exposure time of an image pickup unit, thereby guaranteeing stable image quality.

While the present invention has been described with reference to exemplary embodiments thereof, it will be understood by those skilled in the art that various changes in form and details may be made therein without departing from the scope of the present invention as defined by the following claims.

What is claimed is:

1. A mobile communication terminal comprising:
a camera module for acquiring digital image data;
a storage unit for storing the acquired digital image data;
a display unit for displaying the acquired digital image data; and
a control module for calculating mean luminance values of frames acquired during a predetermined time, calculating an image's luminance value by averaging the mean luminance values of all the frames except frames having significantly high deviations in mean luminance, and transmitting to the camera module a control instruction for controlling an exposure time based on the image's luminance value at regular intervals.

2. The mobile communication terminal of claim 1, wherein the control instruction outputted from the control module is data associated with the number of frames per second.

3. The mobile communication terminal of claim 1, further comprising a signal processing module for processing the digital image data outputted from the camera module, storing the processed digital image data in the storage unit, and outputting to the display unit the digital image data which is processed or read from the storage unit.

4. The mobile communication terminal of claim 3,
wherein the signal processing module further comprises a color converter for converting color component values of the digital image data, and
the control module comprises:
a luminance calculator for calculating a luminance value of a target object from the digital image data;
an exposure controller for determining an exposure time of a image pickup unit on the basis of the luminance value calculated by the luminance calculator, and transmitting an exposure time control instruction to the camera module; and
a color conversion controller for controlling a color conversion scheme of the color converter on the basis of the luminance value calculated by the luminance calculator.

5. The mobile communication terminal of claim 4, wherein the color converter selects any one of conversion tables according to a control instruction of the color conversion controller, and performs a mapping operation of at least U and V signals from among input signals by the selected conversion table.

6. The mobile communication terminal of claim 1, wherein the control module comprises:
a luminance calculator for calculating an image's luminance value by calculating mean luminance values of frames acquired during a predetermined time and averaging the mean luminance values of all the frames except frames having significantly high deviations in mean luminance; and
an exposure controller for transmitting to the camera module a control instruction for controlling an exposure time based on the image's luminance value at regular intervals.

7. The mobile communication terminal of claim 6, wherein the luminance calculator calculates an image's luminance value by averaging mean luminance values of all frames during a predetermined time except frames having mean luminance values greater than a mean luminance value of a previous frame by a predetermined value.

8. The mobile communication terminal of claim 7, further comprising a signal processing module for processing the digital image data outputted from the camera module, storing the processed digital image data in the storage unit, and outputting to the display unit the digital image data which is processed or read from the storage unit.

9. The mobile communication terminal of claim 8,
wherein the signal processing module further comprises a color converter for converting color component values of the digital image data, and
the control module comprises:
a luminance calculator for calculating a luminance value of a target object from the digital image data;
an exposure controller for determining an exposure time of a image pickup unit on the basis of the luminance value calculated by the luminance calculator, and transmitting an exposure time control instruction to the camera module; and
a color conversion controller for controlling a color conversion scheme of the color converter on the basis of the luminance value calculated by the luminance calculator.

10. The mobile communication terminal of claim 9, wherein the color converter selects any one of conversion tables according to a control instruction of the color conversion controller, and performs a mapping operation of at least U and V signals from among input signals by the selected conversion table.

11. The mobile communication terminal of claim 6, wherein the luminance calculator calculates an image's luminance value by calculating a mean value of the mean luminance values of the frames acquired during the predetermined time, and averaging the mean luminance values of all the frames except frames having significantly high deviations as compared to the calculated mean value of the mean luminance values of the frames.

12. The mobile communication terminal of claim 6, wherein the control module controls operation of the camera module using a serial bus.

13. A method of capturing an image using an image pickup unit, comprising the steps of:
a) converting an analog image signal captured by the image pickup unit into digital image data;
b) calculating a luminance value of the image based on the digital image data; and
c) controlling an exposure time of the image pickup unit according to the calculated luminance value.

14. The method of claim 13, wherein the step b) comprises the steps of:
b1) calculating mean luminance values of image frames acquired during a predetermined time; and
b2) calculating an image's luminance value by averaging the mean luminance values of all the frames except frames having significantly high deviations in mean luminance as compared to a reference value.

15. The method of claim 14, wherein the step b2) comprises the step of calculating an image's luminance value by averaging mean luminance values of all frames during a predetermined time except frames having mean luminance values greater than a mean luminance value of a previous frame by a predetermined value.

16. The method of claim 14, wherein the step b2) comprises the steps of:
calculating a mean value of the mean luminance values of the frames acquired during the predetermined time; and
calculating an image's luminance value by averaging the mean luminance values of all the frames except frames having significantly high deviations as compared to the calculated mean value of the mean luminance values of the frames.

17. The method of claim 14, further comprising the step of d) performing a mapping operation of colors of the digital image data according to the calculated image's luminance value.

18. The method of claim 17, wherein the step d) comprises the step of selecting any one of conversion tables and performing a mapping operation of at least U and V signals from among the digital image data by the selected conversion table.

19. The method of claim 17, wherein the step c) comprises the step of controlling the number of frames per second of the image pickup unit.

20. The method of claim 18, wherein the step c) comprises the step of controlling the number of frames per second of the image pickup unit.
